(19) United States
(12) Patent Application Publication
(10) Pub. No.: US 2010/0293028 A1
(43) Pub. Date: Nov. 18, 2010

(54) Method and apparatus for evaluating content

(75) Inventor: Amod Ashok Dange, Venice, CA (US)

Correspondence Address: Amod Ashok Dange, 11905 Venice Blvd, Apartment 14, Los Angeles, CA, 90066, US

(73) Assignee: Amod Ashok Dange, Venice, CA (US)

(21) Appl. No.: 12/463,599

(22) Filed: May 11, 2009

(51) Int. Cl. G06Q 10/00; G06Q 50/00; G06Q 20/00

(52) U.S. Cl. 705/9; 705/10

(57) ABSTRACT

A content evaluation system having a center (10) for receiving new content (12A, 12B) and an evaluation fee (13A, 13B) from content producers (11A, 11B). The center conducts a test (15) to qualify professional content evaluators (14A, 14B), and provides them with access (17A, 17B) to an evaluation apparatus (18). Content producers may apply to become qualified content evaluators. The center uses a queuing system (16) to assign content to evaluators in such a way that producers are never assigned their own content for evaluation. The evaluators submit evaluation data (19A, 19B) to the center and receive remuneration (20A, 20B) for each validated evaluation. The evaluator's remuneration is a portion of the evaluation fee paid by the producer. A content evaluation report (21A, 21B) is generated and shared with the content's producer, who may choose to either have it published in a catalog (22), or to withhold it. The producer may improve and resubmit withheld content to the center. The center offers catalog access (23) to the content's potential audience (24) for an access fee (25).

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

The present invention relates to content, specifically to an improved method and apparatus for evaluating content.

2. Prior Art

Historically, content providers such as record labels, movie studios, book publishers etc. have played a central role in finding new and unknown talent and developing it for mass consumption. Today, as artists produce content cheaply and self-distribute it over the Internet, the amount of content in the marketplace is vast. Audiences find it hard to determine the quality of new and unknown content, and producers find it difficult to make their content discoverable, no matter how high its quality.

U.S. Pat. No. 5,983,214 to Lycos, Inc. discloses a method of computing the value of content for a user by combining the user's profile data with the content's profile data. While this can measure the content's relevance to the user's individual preferences, it cannot determine the sheer quality of the content. For instance, a Jazz fan can find Jazz tunes; there's just no telling whether the artist will be an unknown genius, or an amateur tinkering with an untuned instrument.

U.S. Pat. No. 6,041,311 to Microsoft Corporation discloses a method for recommending items to users based on ratings given to those items by other users possessing similarity factors within, and confidence factors above certain thresholds with respect to the user. This method as well fails to work for new and unknown content. Additionally, since lay audiences provide user ratings, the ratings do not become meaningful until the data sets are sufficiently large. And even then, content is recommended based its popularity, rather than its quality.

U.S. Pat. No. 5,911,131 to Vig discloses a method of appraising artworks by establishing a database of all known artworks of all known artists, and using historical data to predict the normal parameter values of an imaginary artwork produced by the same artist. Such a system is inherently incapable of appraising new and unknown content created by new and unknown artists with no historical data. Further, it focuses on the selling price; since many factors affect an artwork's selling price, this method cannot determine its sheer quality.

Audiences cannot effectively filter content by quality using existing systems. Marketing campaigns often lead them to content that fails to meet their expectations. Too often, the content that is easiest to find also tends to be the most mediocre.

Just as producers cannot effectively demonstrate their content's quality through advertising, advertising cannot guarantee that consumers will notice the high quality content being offered. Yet advertising plays a big part. Low quality content with a high marketing budget routinely outsells high quality content without a marketing budget in the same marketplace.

Critically, producers themselves cannot provide objective quality-related data about their own content; only users can give credible ratings to benefit future users. Hence, for new and unknown content to demonstrate its quality to potential users, some users must risk their time to try it. Due to this paradox, an enormous amount of high quality content remains undiscovered by its potential consumers, many of whom spend time trying content that they determine—after consuming it—to be of low quality.

### SUMMARY

In accordance with one embodiment, the method for evaluating content comprises a center where producers submit their content and pay an evaluation fee. The center qualifies professional evaluators and provides them with access to the content and a computer apparatus using which they conduct evaluations.

In accordance with another embodiment, a computer apparatus enables professional evaluators to evaluate content efficiently. Multiple evaluations are combined to compute the content's rating, which is published in a catalog accessed by the content's potential audience.

Thus the professional, confidential, and fair evaluation of all new and unknown content, and its placement in a catalog, is a substantially more certain and economical way for content producers to reach potential audiences, as well it is a more certain way for audiences to find high quality content in a category of their choice.

### DRAWINGS

### Figures

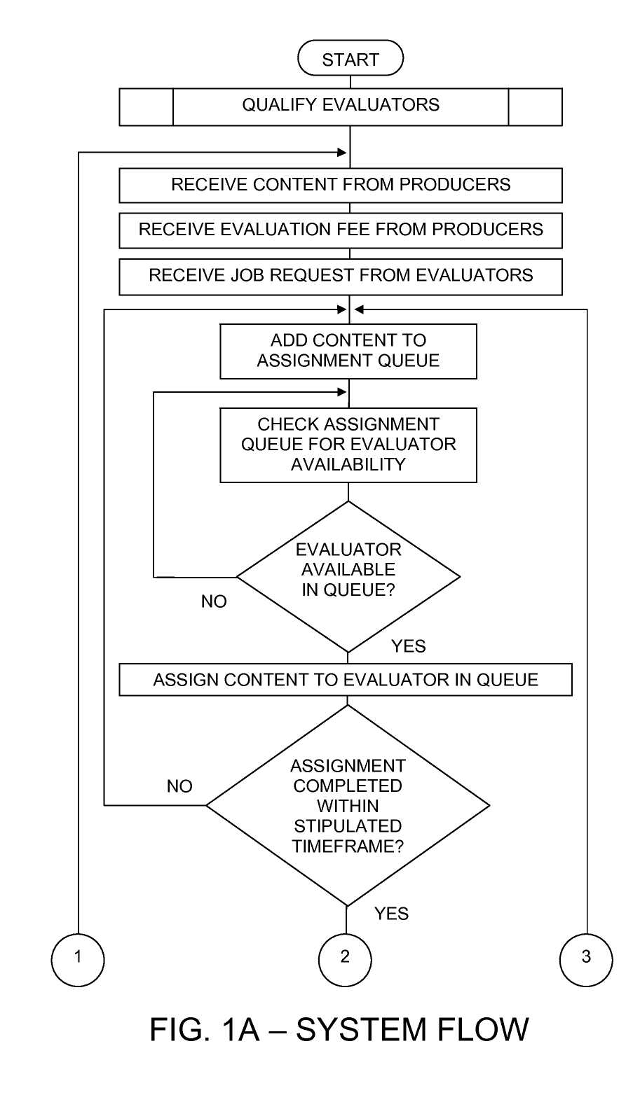

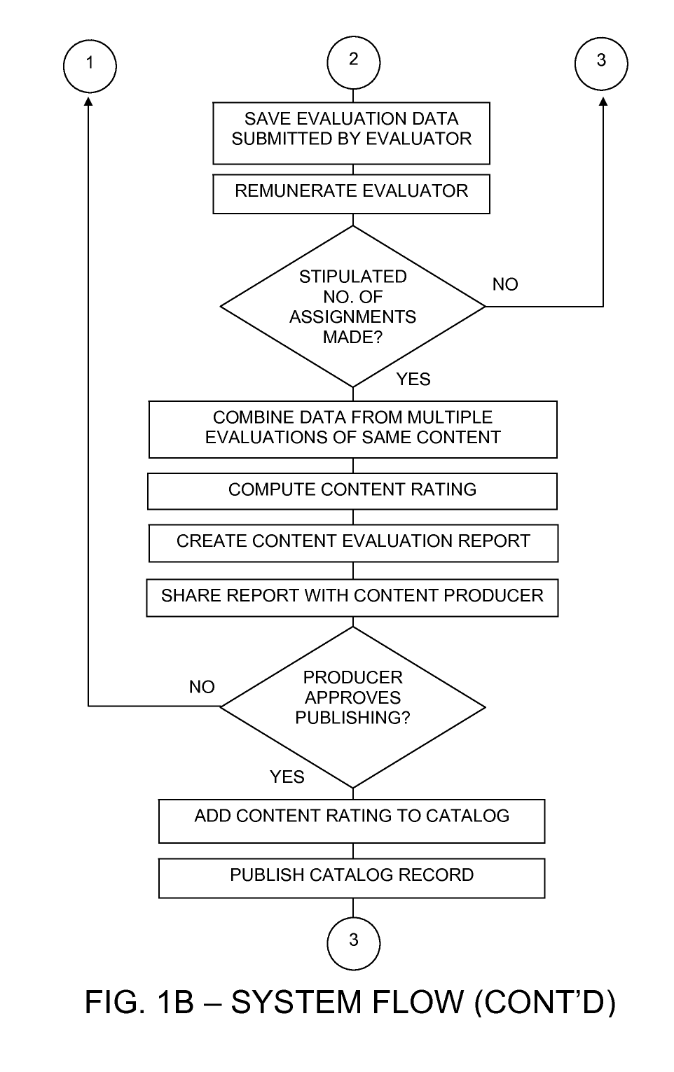

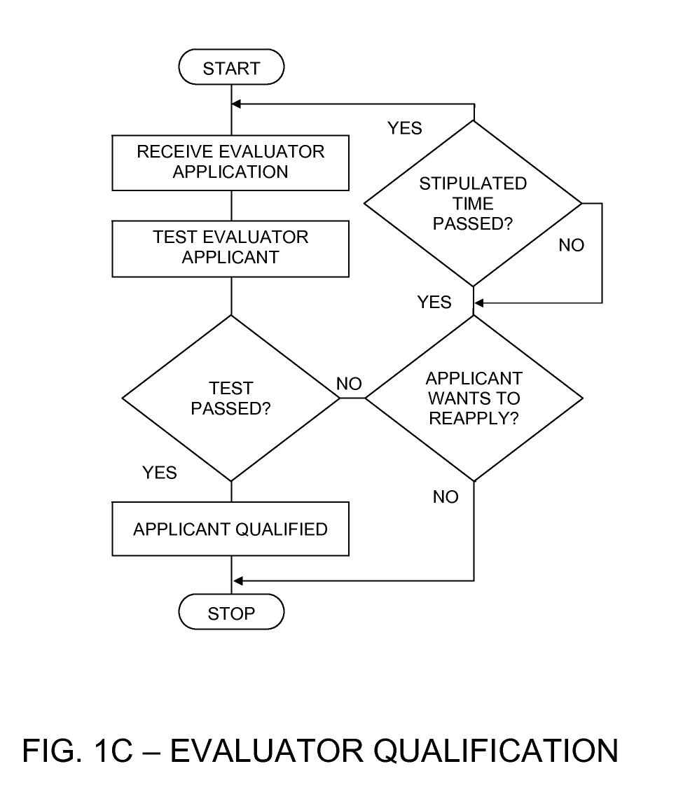

FIGS. 1A, 1B and 1C are a flowchart of the system utilized in the present invention.

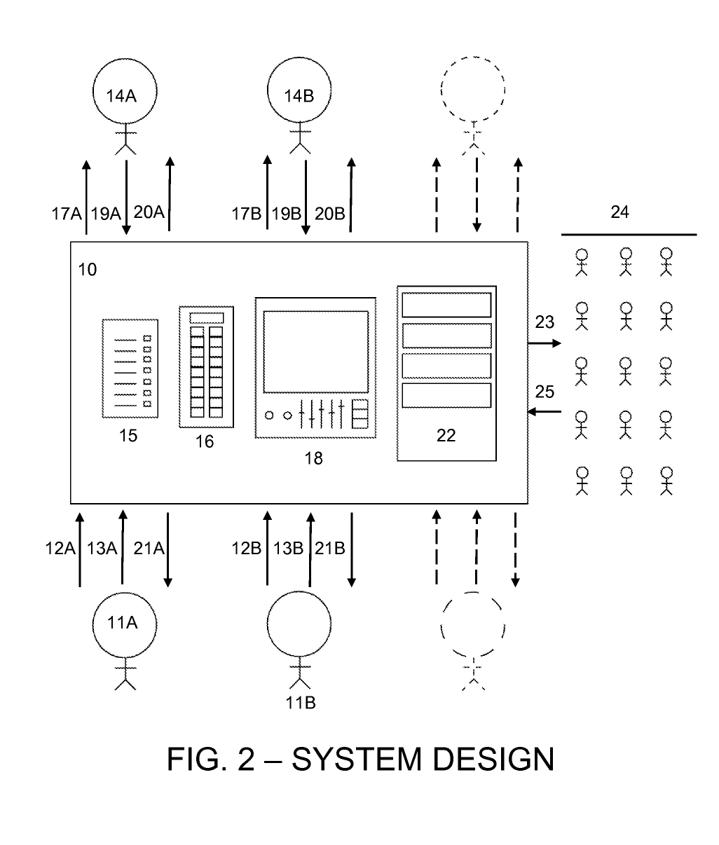

FIG. 2 is an illustrative block diagram of the method in accordance with one embodiment.

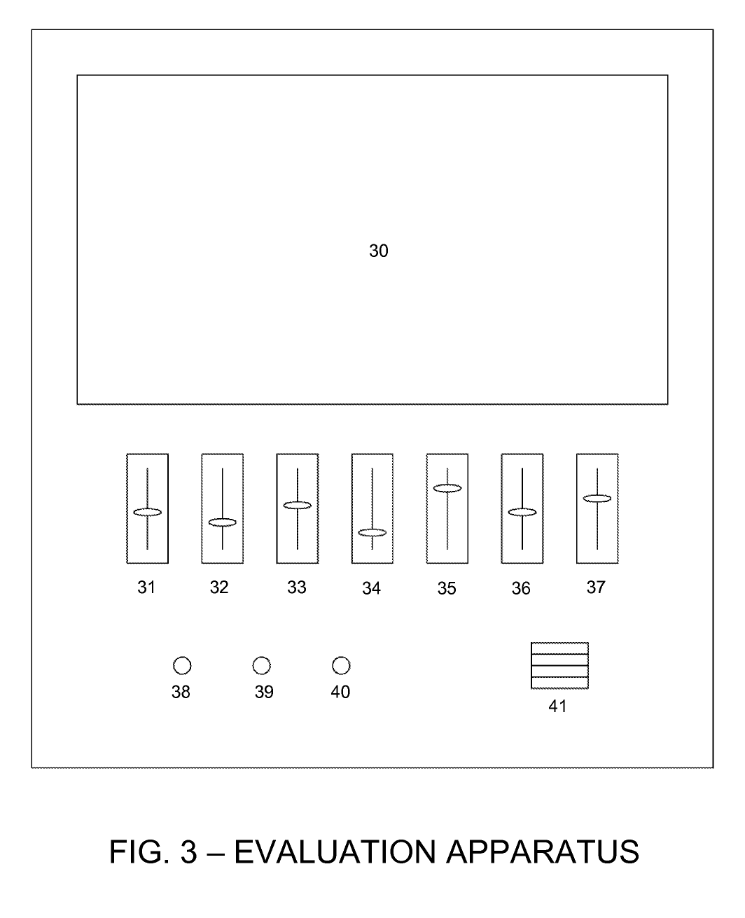

FIG. 3 is an illustration of the apparatus in accordance with another embodiment.

### Referenced Numerals

10 center
11A, 11B content producer
12A, 12B content
13A, 13B evaluation fee
14A, 14B qualified professional evaluator
15 evaluator qualification test
16 assignment queue
17A, 17B access to content
18 evaluation apparatus
19A, 19B evaluation data
20A, 20B evaluator remuneration
19 evaluated content catalog
22 access to content ratings
23 audience
30 content display area
31 through 37 sliders
38, 39, 40 option buttons
41 database

### DETAILED DESCRIPTION

### FIGS. 1 and 2

### First Embodiment

One embodiment of the invention is illustrated in FIG. 1A, FIG. 1B, FIG. 1C and FIG. 2. As shown in FIG. 2, a physical or web-based center 10 is provided where a content producer 11A, 11B can submit new content 12A, 12B, and pay an evaluation fee 13A, 13B. A plurality of professional evaluators 14A, 14B is qualified through a testing process 15. Content producers themselves may apply to become qualified evaluators. The new content received by the center is assigned to a predetermined number of evaluators in a queue 16 in such as way that those evaluators who are also producers will never be assigned their own work for evaluation. The evaluators get access 17A, 17B to the submitted content and an evaluation apparatus 18. Using the apparatus, they complete the evaluations assigned to them efficiently and consistently. Evaluators submit evaluation response data 19A, 19B to the center within a specified timeframe and get remuneration 20A, 20B for each successful evaluation. The center pays the evaluators' remuneration out of the evaluation fee 13A, 13B paid to it by the content producers. Evaluation data received from various evaluators in relation to a particular work is combined to compute a content rating and generate a content evaluation report 21A, 21B. The report is shared with the content's producer 11A, 11B. The producer may approve or withhold publishing of the ratings in a catalog 22. Catalog access 23 is offered to a potential audience 24 for an access fee 25. The content producer can use the content evaluation report to make improvements in withheld content and resubmit it through the same process.

### FIG. 3

### Additional Embodiments

Another embodiment of the invention is shown in FIG. 3, which is an illustration of the evaluation apparatus 18 (FIG. 2). The evaluation apparatus can be software or hardware, or a combination of the two. A qualified professional evaluator 14A, 14B (FIG. 2) experiences the content in a display area 30 and assigns values to a plurality of sliders 31 through 37. Each slider corresponds to an evaluation parameter. The evaluator records opinion regarding a parameter related to the content by choosing from a set of option buttons 38, 39, 40. When a value is attached to a parameter, it is stored in database 41.

### Advantages

From the description above, a number of advantages of some embodiments of my method of determining quality of content become evident:
a) The content's relevance to the user's preferences is inconsequential if its quality is below par. My method evaluates the content's quality, which is of primary importance.
b) Unpaid users cannot be expected to perform parametric evaluations. Non-parametric ratings are subjective, and often merely reflect the user's preferences. My evaluation apparatus uses multiple objective parameters such as those related to the artist's level of mastery of the craft, thus resulting in more credible ratings.
c) In my method, a smaller number of evaluations can produce meaningful ratings, as the evaluations are parametric and performed by professionals. In free non-parametric user-rating based systems, even large numbers of ratings reflect little more than the content's popularity, which may not be meaningful to an audience that seeks quality.
d) My method remunerates evaluators, thus ensuring that all content is rated. In free user-rating based systems, content often remains unrated.
e) Content producers finance the professional evaluation of their new and unknown content through a small and fixed evaluation fee. This removes from the audience the burden of trying new and unknown content.
f) Evaluations conducted using my evaluation apparatus are more reliable than superficial user ratings.
g) The playing field in the content market is leveled as content filtration centers on quality, thus promoting merit over marketing.
h) Content producers save advertising costs and instead, pay a small fixed fee to have their content professionally evaluated, and its rating published in a searchable catalog.
i) Audiences have the ability to easily find high quality content from the vast amount of new and unknown content available at any given time.
j) Producers receive a thorough content evaluation report. They may choose not to publish the content rating of it is low, and instead, use the report to make improvements in the content and resubmit it through the same process. This results in an improvement in the overall quality of content in the marketplace.
k) Artists have an opportunity to apply their knowledge of the craft and make a living as self-employed professional evaluators, as they continue to pursue their art.
l) Irrespective of geographic location, anyone with the requisite knowledge can turn their passion for art into a rewarding new profession in content evaluation.
m) Such a global content evaluation system creates new opportunities for artists to reach foreign markets hitherto inaccessible to them.
n) Local content markets break free from mainstream mediocrity, as the global content market further integrates, enriching the lives of consumers with an infusion of diverse cultural elements from all over the world.

### CONCLUSION, RAMIFICATION AND SCOPE

Accordingly, the reader will see that the various embodiments of the method and apparatus for evaluating content will create a meritocracy in the arts on an unprecedented scale.

In the digital era, production and distribution cost barriers have largely disappeared for producers, but the resulting vast quantity of content poses a new content noise barrier. The present invention successfully removes this barrier, providing a fair system in which producers have the opportunity to make themselves discoverable simply on the basis of the quality of their content, and nothing else.

Consumers as well face the problem of determining the quality of new and unknown content in the absence of a true meritocracy. The present invention solves this problem and provides a reliable resource to consumers for finding new content that is more likely to satisfy their needs.

Although the description with reference to the drawings contains many specificities, these should not be construed as limiting the scope of the embodiments but as merely providing illustrations of a small number of the many possible specific embodiments, which can represent applications of the principles of the present invention. For example, depending on the type of content being evaluated, tools other than sliders and option buttons may be used to record evaluation parameter values. Another example of alternative embodiments is the number of evaluators that are assigned the same content. To obtain useful evaluation data sets while keeping the process economical for all the entities in the system, this number may be varied to suit different content types.

### Examples

1. Screenwriters submit their scripts and pay an evaluation fee through a website. Qualified professional script evaluators download scripts assigned to them into a software application that lets them read and rate the scripts. Script ratings are stored in a web catalog accessed by script buyers.
2. Music producers submit their songs and pay an evaluation fee through a website. Qualified professional music evaluators download songs assigned to them into a mobile phone software application that lets them play and rate the songs. Song ratings are stored in a web catalog accessed by music buyers.

These and various other changes and modifications obvious to one skilled in the art to which the present invention pertains are deemed to be within the spirit, scope and contemplation of the present invention as further defined in the appended claims.

I claim:

1. A method of evaluating the quality of content, comprising:
(a) providing a center where a producer can submit said content
(b) providing a center where said producer can pay a fee
(c) providing a means for qualifying a content evaluator
(d) assigning said content to a plurality of said qualified content evaluators such that no evaluators are assigned content produced by themselves
(e) providing a means for said qualified content evaluators to evaluate said content
(f) providing a center where said qualified content evaluators can submit evaluation data in respect of said content
(g) disbursing portions of said fee to said qualified content evaluators
(h) providing a means to store said evaluation data

2. The method of claim 1 wherein step (e) further comprises an apparatus for evaluating content, comprising:
(a) a means to perform, display, or represent said content
(b) a means to assign values to a plurality of parameters relating to the quality of said content
(c) a database which is able to store said values.
